(19) United States
(12) Patent Application Publication
(10) Pub. No.: US 2024/0378742 A1
(43) Pub. Date: Nov. 14, 2024

(54) TONG ASSEMBLY VERTICAL POSITIONING FOR PIPE CONNECTION MAKE-UP AND BREAK-OUT

(71) Applicant: WEATHERFORD TECHNOLOGY HOLDINGS, LLC, Houston, TX (US)

(72) Inventors: Benjamin SACHTLEBEN, Hannover (DE); David GEISSLER, Hannover (DE); Andreas BRUENING, Burgwedel (DE); Rainer RUEHMANN, Hannover (DE)

(21) Appl. No.: 18/314,358

(22) Filed: May 9, 2023

(51) Int. Cl. G06T 7/73; E21B 19/16; G06T 7/50; G06V 10/44; G06V 10/56; G06V 20/50

(52) U.S. Cl. CPC G06T 7/73; E21B 19/161; E21B 19/165; G06T 7/50; G06V 10/443; G06V 10/56; G06V 20/50; G06T 2207/10024; G06T 2207/20061; G06T 2207/20081; G06T 2207/20084; G06T 2207/30204

(57) ABSTRACT

A system can include a tong assembly, a tong positioning device configured to adjust a vertical height of the tong assembly, one or more calibration marker secured to the tong assembly, and a camera disposed at a camera position at which the calibration marker is within a field of view of the camera. A method of vertically positioning a tong assembly can include taking a digital image of a tong assembly and one or more calibration marker, identifying a pixel position of the calibration marker in the digital image, and adjusting a height of the tong assembly based in part on the pixel position of the calibration marker.

### BACKGROUND

This disclosure relates generally to equipment utilized and operations performed in conjunction with a subterranean well and, in an example described below, more particularly provides for vertically positioning a tong assembly to perform a pipe connection make-up or break-out.

In a variety of different well operations, sections of pipes are threaded together (make-up) or unthreaded from each other (break-out). To perform the threading or unthreading, a tong assembly is typically used to grip, rotate and apply torque to the pipe sections. A conventional tong assembly can include a power or rotary tong to grip, rotate and apply torque to one of the pipe sections, and a stationary or back-up tong to grip the other pipe section and react the torque applied by the rotary tong.

It will, therefore, be readily appreciated that improvements are continually needed in the arts of constructing and utilizing tong assemblies and systems with well operations. Such improvements may be used with various different types of tong assemblies in a variety of different well operations (such as, drilling, running casing, installing or retrieving production tubing, etc.).

### BRIEF DESCRIPTION OF THE DRAWINGS

FIG. 1 is a representative side view of an example of a well system and associated method which can embody principles of this disclosure.

FIG. 2 is a representative side view of an example of a camera and a calibration marker that may be used in the FIG. 1 system and method.

FIG. 3 is a representative flowchart for an example of a calibration procedure that may be used with the FIG. 1 system and method, and the FIG. 2 camera and calibration marker.

FIG. 4 is a representative side view of the system and method, with an example of a tong assembly being used to make-up or break-out a pipe connection.

FIG. 5 is a representative flowchart for an example of a procedure for vertically positioning the tong assembly.

FIG. 6 is a representative flowchart for an example of a procedure for monitoring the make-up or break-out of the pipe connection.

FIG. 7 is a representative example of a digital image of the tong assembly taken in a training or calibration procedure.

FIG. 8 is a representative example of a digital image of connected pipes in a training procedure or in a well operation.

FIG. 9 is a representative example of a digital image of the tong assembly and connected pipes in a well operation.

### DETAILED DESCRIPTION

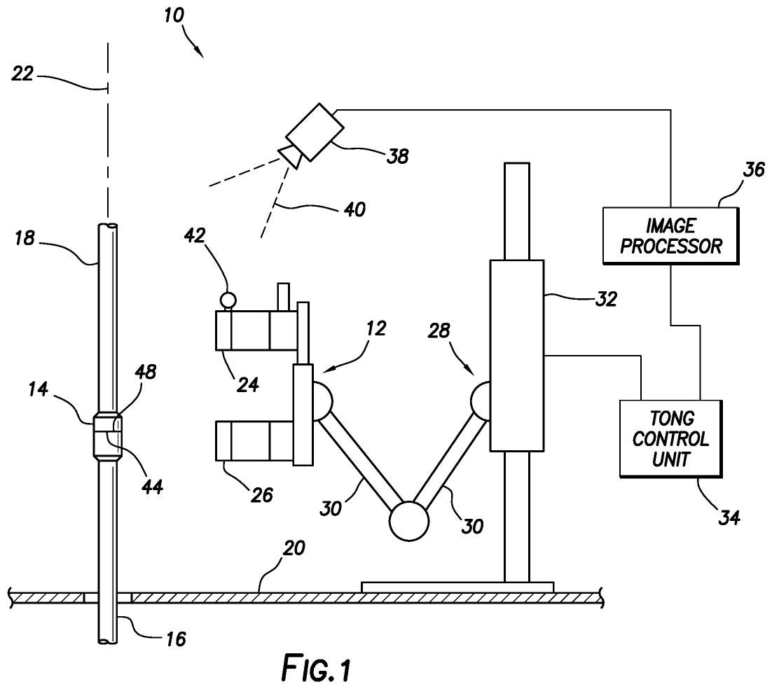

Representatively illustrated in FIG. 1 is a system 10 for use with a subterranean well, and an associated method, which can embody principles of this disclosure. However, it should be clearly understood that the system 10 and method are merely one example of an application of the principles of this disclosure in practice, and a wide variety of other examples are possible. Therefore, the scope of this disclosure is not limited at all to the details of the system 10 and method described herein and/or depicted in the drawings.

In the FIG. 1 example, a tong assembly 12 is used to make-up or break-out a connection 14 between pipes 16, 18. The lower pipe 16 extends into the well through a rig floor 20. The pipes 16, 18 are axially aligned with a central axis 22 of the well (also known to those skilled in the art as “well center”).

As depicted in FIG. 1, each of the pipes 16, 18 has threaded ends that are “externally upset” (having radially enlarged ends), with an internally threaded end and an opposite externally threaded end. In other examples, internally threaded collars may be used to connect externally threaded ends of the pipes 16, 18. The pipes 16, 18 may be tubulars of the type known to those skilled in the art as drill pipe, casing, production tubing or liner. The scope of this disclosure is not limited to use of any particular type of pipe or tubular, or to any particular type of threaded connection between pipes or tubulars.

It is desired in the system 10 to align the tong assembly 12 with the pipe connection 14, so that the tong assembly can be used to make-up or break-out the connection. The tong assembly 12 in this example includes a rotary tong 24 to grip, rotate and apply torque to the upper pipe 18, and a back-up tong 26 to grip the lower pipe 16 and react the torque applied by the rotary tong.

The tong assembly 12 is aligned with the pipe connection 14 when the tong assembly is positioned at the central axis 22, the rotary tong 24 is above the pipe connection 14, and the back-up tong 26 is below the pipe connection. Note that, if the tong assembly 12 is being used to make-up the pipe connection 14, the upper pipe 18 will typically not be fully threaded into the lower pipe 16 at the time the tong assembly is initially aligned with the pipe connection.

In the FIG. 1 example, a positioning device 28 is used to change the vertical and horizontal positions of the tong assembly 12. The FIG. 1 positioning device 28 includes positioning arms 30 and an actuator 32. In other examples, the positioning device 28 could be the same, or similar to, equipment known to those skilled in the art as an “iron roughneck” including a frame displaceable along tracks in the rig floor 20, with the tong assembly 12 being suspended from the frame. The scope of this disclosure is not limited to use of any particular type of positioning device, or to any particular manner of horizontally or vertically positioning a tong assembly.

Operation of the tong assembly 12 and the positioning device 28 is controlled by a tong control unit 34. The tong control unit 34 can include components, such as, one or more processors or computers, memory for storing instructions, data, etc., input and output devices (e.g., a display, printer, keypad, touch screen, joystick, switches, etc.), a programmable logic controller, and/or other components or combinations of components. The scope of this disclosure is not limited to any particular configuration of the tong control unit 34.

As depicted in FIG. 1, a separate image processor 36 is connected to the tong control unit 34. The image processor 36 receives digitized images taken by a camera 38. The camera 38 is positioned, so that the pipe connection 14 and the tong assembly 12 are within a field of view 40 of the camera during the make-up or break-out process. In addition, the tong assembly 12 is within the field of view 40 of the camera 38 during a calibration process, as described more fully below.

Although the tong control unit 34 and the image processor 36 are depicted in FIG. 1 as being separate, in other examples they could be combined into a single item of equipment, or they could be divided into additional units. It is not necessary for all functions performed by the tong control unit 34 and the image processor 36 to be performed locally at the well site. For example, some computations, data input or output, training, calibration, etc., could be performed remotely via wired, wireless, satellite or Internet communication.

In the FIG. 1 example, a calibration marker 42 is secured in a known position to the tong assembly 12. The calibration marker 42 depicted in FIG. 1 is in the shape of a sphere and is attached to the rotary tong 24, but other shapes and other attachment locations may be used in other examples.

The calibration marker 42 may have a distinctive color. The color may be different from the colors of other equipment within the field of view 40 of the camera 38, so that the calibration marker 42 can be more readily identified in digital images taken by the camera. However, the scope of this disclosure is not limited to use of a distinctive color for the calibration marker 42.

A vertical height of the calibration marker 42 corresponds to a tong reference height. If the vertical height of the calibration marker 42 is known, then vertical heights of all of the components of the tong assembly 12 (such as, the rotary tong 24 and the back-up tong 26) are also known.

However, note that, using the procedures described more fully below, it is not necessary to obtain measurements of vertical heights above the rig floor 20. Instead, the vertical positions of the tong assembly 12, the pipe connection 14 and a reference height of the positioning device 28 are related to pixel positions in the digital images taken by the camera 38. The position of the camera 38 does not change between the digital images taken during calibration and the make-up or break-out procedures, and so the vertical height corresponding to a pixel position in one digital image will be the same as the vertical height corresponding to the same pixel position in another digital image (as long as the pixel positions are along a same vertical axis).

As used herein, the term “pixel position” is used to indicate a position of an element (such as, an upper end of a pipe, a connection between two pipes, or a trackable feature on a pipe) identified in a digital image taken by a camera. Typically, the digital image represents a two-dimensional space within a field of view of the camera. However, in some examples a camera may be configured to represent a three-dimensional volume (including depth) within the field of view of the camera. The term “pixel position” as used herein can include a vertical component of a resulting “voxel position” in the three-dimensional volume.

The vertical height of the tong assembly 12 corresponds to the reference height of the positioning device 28. The reference height of the positioning device 28 is a digital value used by the tong control unit 34 to control actuation of the positioning arms 30 and actuator 32, so that the tong assembly 12 is moved to a desired vertical height. There should be a direct correspondence between the positioning device 28 reference height and the tong assembly 12 vertical height, but there is a possibility that mechanical malfunction or other issues could change the relationship between the positioning device 28 reference height and the tong assembly 12 vertical height, so in one example described below, identification of such issues is provided for.

As depicted in FIG. 1, the pipe connection 14 is at a vertical height. More specifically, in this example, an external interface 44 (e.g., a connection line) between shoulders on the ends of the pipes 16, 18 is at the vertical height. In order to position the tong assembly 12, so that the rotary tong 24 is above the pipe connection 14 and the back-up tong 26 is below the pipe connection, the reference height of the positioning device 28 is adjusted by the tong control unit 34, based on the digital images taken by the camera 38 and processed by the image processor 36.

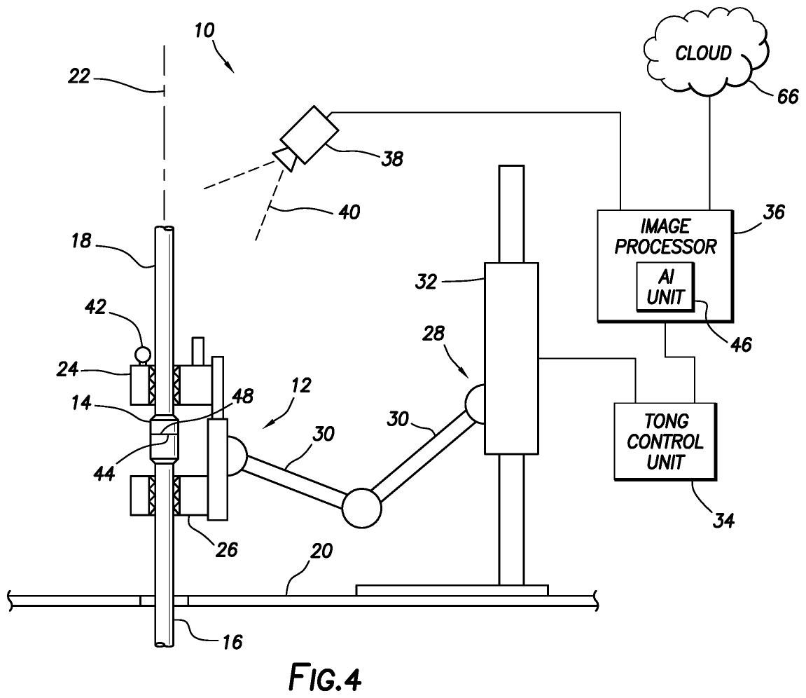

To accomplish this result, an artificial intelligence unit 46 (not shown in FIG. 1, see FIG. 4) is trained to identify positions (in photo pixels) of the calibration marker 42, and an upper end 48 of the lower pipe 16 and/or the interface 44 between the pipes 16, 18. The artificial intelligence unit 46 is preferably trained prior to use of the artificial intelligence unit at the well site. The artificial intelligence unit 46 may comprise at least one of an artificial neural network, a genetic algorithm, a convolutional neural network, a recurrent neural network and machine learning. However, the scope of this disclosure is not limited to use of any particular type of artificial intelligence.

A calibration process is then performed at the well site to determine an algorithmic relationship between photo pixel position and the tong assembly positioning device 28 reference height using a fixed camera 38 position. After calibration, the vertical height of the tong assembly 12 is appropriately adjusted, so that it can be used to make-up or break-out the connection 14 between the pipes 16, 18.

Data generated during the well site operation can be used to update parameters of the artificial intelligence unit 46 (such as, weights and node configurations of a neural network) in further training of the artificial intelligence unit. In this manner, the artificial intelligence unit 46 can be progressively trained with operational data from multiple locations, and distributed back to the various systems 10 at those locations.

One example of the initial training of the artificial intelligence unit 46 can include the following steps:

1. Accumulate photos (digital images) of the calibration marker, upper ends of pipe and connections between pipes.

2. An area of interest is identified in each of the photos. The area of interest includes an image of a calibration marker, an upper end of a pipe or a connection line (external interface) between two pipes.

3. Process photos in the respective areas of interest to identify edges (e.g., using Canny edge detection) and shape of calibration marker (e.g., using Circle Hough Transform if the calibration marker shape is spherical or circular). If the calibration marker has a distinctive color, other colors can be filtered out of the photos of the calibration marker.

4. Manually identify pixel positions of calibration marker, upper ends of pipe and connection lines between pipes in photos.

5. Input processed photos and manually identified pixel positions to the artificial intelligence unit. This will begin the training of the artificial intelligence unit.

6. Input additional processed photos to the artificial intelligence unit, so that the artificial intelligence unit will predict pixel positions of the calibration marker, upper ends of pipe and connections between pipes in the photos. An operator determines whether, for each photo, the artificial intelligence unit has correctly predicted the pixel positions of the calibration marker, upper ends of pipe and connections between pipes in the photos. This further trains the artificial intelligence unit.

7. Step 6 is repeated until the artificial intelligence unit successfully identifies the pixel positions of the calibration marker, upper ends of pipe and connections between pipes in the processed photos. At this point the artificial intelligence unit is acceptably trained for deployment.

8. The artificial intelligence unit is further trained after deployment using data from well site operations.

One example of the calibration process can include the following steps:

1. Tong assembly with calibration marker is moved to (or very near) a central vertical axis of the well (well center) at a known positioning device reference height.

2. A distance between the calibration marker and the camera is measured.

3. A photo of the calibration marker is taken by the camera.

4. Steps 2 & 3 are repeated for at least one additional vertical height of the tong assembly with calibration marker at (or very near) the central vertical axis of the well.

5. The photos are processed (e.g., identifying an area of interest in each photo, and then using Canny edge detection and optionally a Circle Hough Transform, and possible color filters) and input to the trained artificial intelligence unit. The artificial intelligence unit identifies the pixel positions of the calibration marker in the processed photos.

6. Using the known geometry (camera position and distance from the central vertical axis of the well, camera focal length, the pixel heights of the calibration marker/positioning device, etc.) and standard trigonometric principles, the algorithmic relationship between photo pixel position and positioning device reference height is determined.

7. There is a known vertical distance between the calibration marker and the various components of the tong assembly. Thus, if the pixel position of the calibration marker is known, the relative positions of the various components of the tong assembly (e.g., the power and back-up tongs) are also known. As discussed above, the pixel position of the calibration marker corresponds to a certain positioning device reference height.

One example of operation of the system 10 at a well site can include the following steps:

1. An upper end of a pipe, or a connection between two pipes, is positioned at a location above the rig floor (e.g., using an elevator and a hoisting device, such as, a top drive or draw-works, and secured using slips in the rig floor).

2. The camera takes a photo of the upper end of the pipe, or the connection between two pipes. The camera remains in the same position as it was in the calibration procedure.

3. The photo is processed (e.g., identifying an area of interest in the photo, and then using Canny edge detection on the area of interest) and input to the trained artificial intelligence unit. The artificial intelligence unit identifies the pixel position of the upper end of the pipe, or the connection between two pipes in the processed photo.

4. The algorithmic relationship determined in the calibration procedure is used to calculate a height of the upper end of the pipe, or the connection between two pipes.

5. For a break-out, the positioning device reference height is adjusted so that one tong is higher than the connection between the pipes and the other tong is lower than the connection, the tong assembly is then moved to well center, the tongs are actuated to grip the pipes, and then torque is applied to break-out the connection. For a make-up, a pipe is stabbed into the pipe extending through the rig floor, the positioning device reference height is adjusted so that one tong is higher than the connection between the pipes and the other tong is lower than the connection, the tong assembly is then moved to well center, the tongs are actuated to grip the pipes, and then torque is applied to make-up the connection.

6. During make-up or break-out, the pipe extending through the rig floor should be prevented from rotating by the back-up tong. The camera can be used to monitor the pipe and, if rotation of the pipe is detected during make-up or break-out, the operation can be terminated to prevent damage to the back-up tong jaws or the pipe. The artificial intelligence unit can be trained (similar to the training process described above) to identify one or more features on the pipe, and to detect rotation of the feature(s) in successive images of the pipe taken by the camera.

An example of training the artificial intelligence unit using data from well site operations can include the following steps:

1. Each time the artificial intelligence unit identifies the pixel position of the upper end of the pipe, or the connection between two pipes, in a processed photo, an operator makes a determination whether the identification is correct. If the identification is correct, the operation continues as described above.

2. If the identification is incorrect, the operator can manually identify the pixel position of the upper end of the pipe, or the connection between two pipes, in the processed photo. Alternatively, another photo can be taken with improved/changed conditions (e.g., different background, cleaned pipe connection), the photo is processed and input to the artificial intelligence unit for another attempt at identifying the pixel position of the upper end of the pipe, or the connection between two pipes, in the processed photo.

3. The data generated by this process (including the processed photo, the pixel position identified in the processed photo by the artificial intelligence unit, and the determination whether the identification was correct) is transmitted to the cloud. Data transmitted to the cloud from multiple operations in multiple locations around the world are used to further train a central version of the artificial intelligence unit, which is then periodically or intermittently transmitted to all users of the artificial intelligence unit.

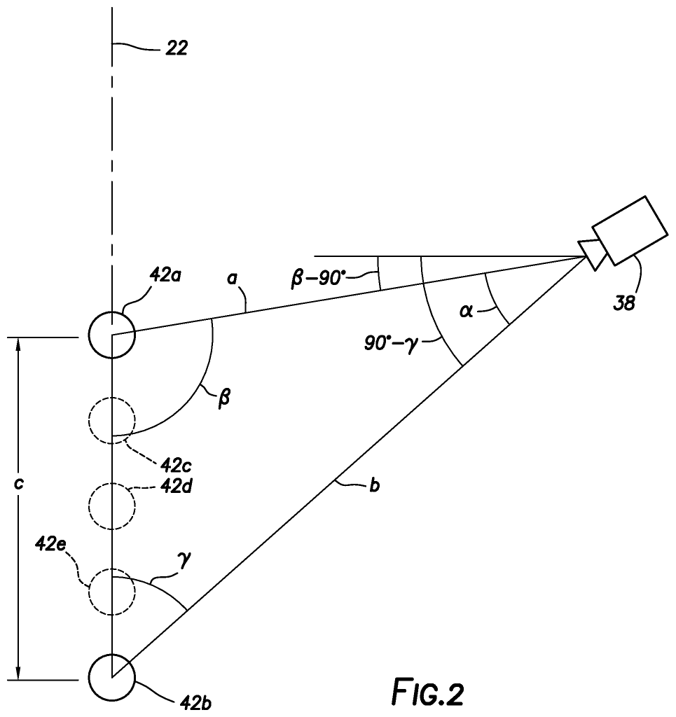

Referring additionally now to FIG. 2, an example of the camera 38 and the calibration marker 42 in the calibration procedure is representatively illustrated. The calibration procedure represented in FIG. 2 is described below as it may be used with the system 10 and method of FIG. 1, but the calibration procedure may be used with other systems and methods in other examples. The calibration marker 42 is depicted in FIG. 2 as being positioned at multiple vertical positions 42a, 42b along the vertical axis 22, but it should be understood that it is the tong assembly 12 that is preferably axially aligned with the central axis 22 (or is very near the central axis) during the calibration procedure.

When the calibration marker 42 is at the first position 42a, the height of the calibration marker corresponds to a first reference height of the positioning device 28 and a first height of the tong assembly 12. The camera 38 takes a first digital image of the calibration marker at the first position 42a. A first pixel position of the calibration marker in the first digital image is identified (either manually or using a trained artificial intelligence unit). A distance a between the camera 38 and the first position 42a is manually measured. Alternatively, the distance a can be calculated, based on a pixel dimension of the calibration marker in the first digital image and known optical characteristics of the camera 38.

When the calibration marker 42 is at the second position 42b, the height of the calibration marker corresponds to a second reference height of the positioning device 28 and a second height of the tong assembly 12. The camera 38 takes a second digital image of the calibration marker at the second position 42b. The position of the camera 38 does not change between taking the first and second digital images. A second pixel position of the calibration marker in the second digital image is identified (either manually or using a trained artificial intelligence unit). A distance b between the camera 38 and the second position 42b is manually measured. Alternatively, the distance b can be calculated, based on a pixel dimension of the calibration marker in the second digital image and the known optical characteristics of the camera 38.

A difference between the heights of the calibration marker at the first and second positions 42a, 42b is the vertical distance c. Using well-known trigonometric principles and the known distances a, b, c, the angles α, β, γ of the triangle vertices can be readily computed. In addition, the height of the calibration marker 42, the reference height of the tong positioning device 28, and the corresponding pixel position of the calibration marker in a digital image taken by the camera 38 will be directly related according to readily determined algorithmic relationships.

Additional vertical positions 42c-e of the calibration marker are depicted in broken lines in FIG. 2. Such additional positions may be used to verify that the determined algorithmic relationships between the heights of the calibration marker 42, the reference heights of the tong positioning device 28, and the corresponding pixel positions of the calibration marker in digital images taken by the camera 38 with the calibration marker at the additional vertical positions 42c-e are correct.

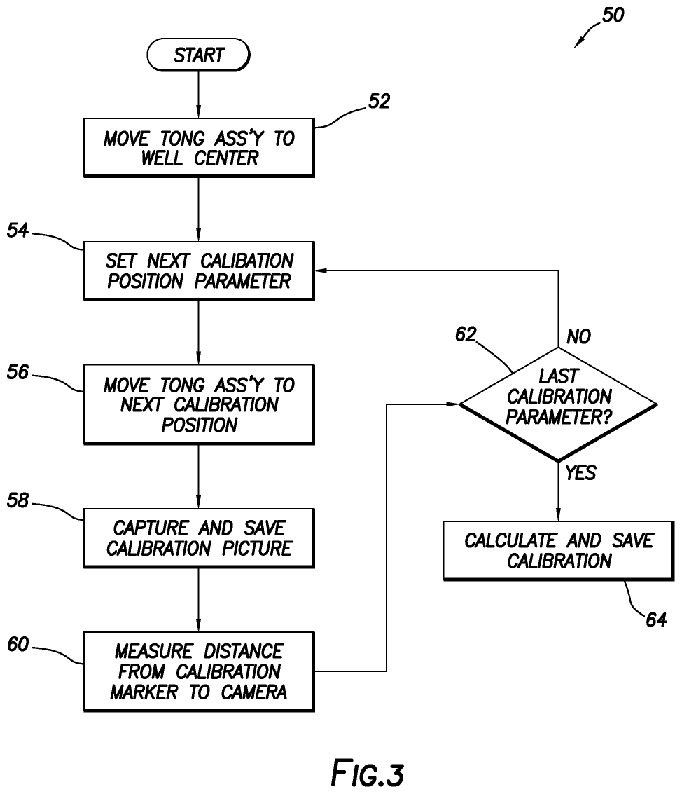

Referring additionally now to FIG. 3, flowchart for an example of the calibration procedure 50 is representatively illustrated. The FIG. 3 calibration procedure 50 is described below as it may be used with the FIG. 1 system 10 and method, but the calibration procedure may be used with other systems and methods in other examples.

In an initial step 52, the tong assembly 12 is moved to the well center. The tong control unit 34 operates the positioning arms 30 and actuator 32, so that the tongs 24, 26 are axially aligned with the central axis 22.

In step 54, a first calibration position parameter is set. The first calibration position parameter in this example is a first reference height of the positioning device 28.

In step 56, the tong assembly 12 is moved by the positioning device 28 so that its height corresponds to the first reference height of the positioning device 28. Stated differently, the tong control unit 34 operates the positioning arms 30 and actuator 32, according to the first reference height of the positioning device 28, so that the tong assembly 12 is moved to a first calibration position.

In step 58, the camera 38 takes a first photo, picture or digital image of the tong assembly 12 at the first calibration position. The first calibration photo, picture or digital image is saved.

In step 60, a first distance a from the calibration marker 42 to the camera 38 is measured or calculated.

In step 62, a determination is made whether the last calibration parameter (e.g., positioning device 28 reference height) is reached. If not, the procedure 50 returns to step 54, in which a second calibration position parameter is set. Steps 54-62 are repeated until the total number of desired calibration position parameters are used. The total number of calibration position parameters used may be as few as two in some examples.

When the last calibration position parameter has been used, the appropriate algorithmic relationships between the height of the calibration marker 42, the reference height of the tong positioning device 28, and the corresponding pixel position of the calibration marker in a digital image taken by the camera 38 (the calibration) are calculated and saved for later use in well operations.

Referring additionally now to FIG. 4, the system 10 and method are representatively illustrated with the tong assembly 12 being used to make-up or break-out the pipe connection 14. The tong assembly 12 can be used to make-up or break-out the pipe connection 14 after the artificial intelligence unit 46 has been trained and the calibration procedure described above has been performed.

Note that the camera 38 is in the same position in FIG. 4 as it was during the calibration procedure. Thus, pixel positions of objects in digital images taken during the calibration procedure will have the corresponding same heights as the same pixel positions of objects in digital images taken during subsequent well operations.

The tong assembly 12 is axially aligned with the well central axis 22, as it was during the calibration procedure. Thus, the algorithmic relationships between the height of the calibration marker 42, the reference height of the tong positioning device 28, and the corresponding pixel position of the calibration marker in a digital image taken by the camera 38 should remain valid.

When it is desired to perform the make-up or break-out operation, prior to the tong assembly 12 being moved to the position depicted in FIG. 4, the camera 38 takes a digital image of the pipe connection 14 (for a break-out operation) or the upper end 48 of the lower pipe 16 (for a make-up operation). The digital image is processed by the image processor 36. The trained artificial intelligence unit 46 identifies the pixel position of the interface 44 or the upper end 48. If a make-up operation is being performed, the upper pipe 18 is stabbed into the lower pipe 16.

The tong control unit 34 then operates the positioning device 28 to move the tong assembly 12 to the well center and adjusts the height of the tong assembly so that the rotary tong 24 is above the interface 44 or the upper end 48 and the back-up tong 26 is below the interface 44 or the upper end 48. The tongs 24, 26 are activated to grip the respective pipes 18, 16, and then torque is applied by the tongs to the pipes.

As described more fully below, the camera 38 and image processor 36 with the trained artificial intelligence unit 46 can be used to monitor the lower pipe 16 during the make-up or break-out operation, in order to detect any slippage between the lower pipe and the back-up tong 26. After the pipes 16, 18 are made-up or broken-out, the tongs 24, 26 are released from the pipes and the tong assembly 12 is moved away from the well center.

Data generated during the well site operation can be transmitted to a cloud 66 comprising computers or computing devices networked via the Internet. The data can be used to further train a central version of the artificial intelligence unit 46. The further trained artificial intelligence unit 46 (or at least parameters thereof) can then be used to update the artificial intelligence units used in well operations.

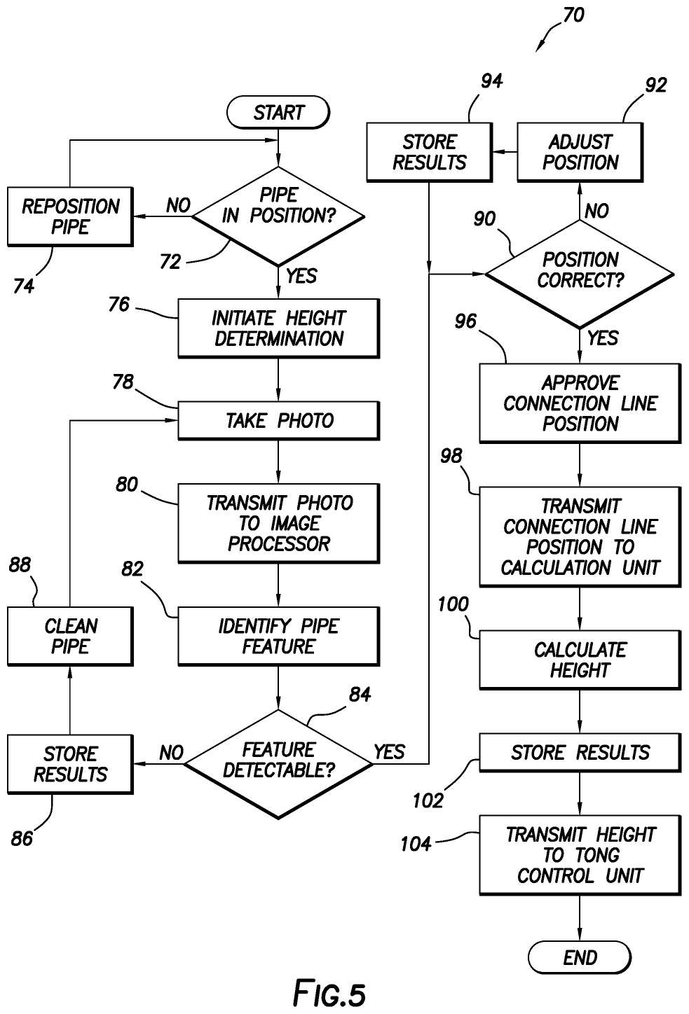

Referring additionally now to FIG. 5, a flowchart for an example of a procedure 70 of vertically positioning the tong assembly 12 is representatively illustrated. The tong assembly positioning procedure 70 is described below as it may be used to break-out the pipe connection 14 in the FIGS. 1 & 4 system 10 and method, but the procedure may be used to make-up a pipe connection, or it may be used with other systems and methods, in other examples.

In step 72, a determination is made whether the pipe connection 14 is in a proper vertical position to be broken-out. Preferably, the pipe connection 14 is within an acceptable vertical height range that will enable the tong assembly 12 to be positioned to break-out the connection.

In step 74, if the pipe connection 14 is not in a proper vertical position, it is repositioned. For example, a top drive or draw-works can be operated to reposition the pipe connection 14.

In step 76, if the pipe connection 14 is confirmed to be in an appropriate position for the break-out operation, a determination of the height of the pipe connection is initiated.

In step 78, a digital image or photo of the pipe connection is taken by the camera 38. The camera 38 remains in the same position as it was during the calibration procedure 50 described above.

In step 80, the digital image is transmitted to the image processor 36. The digital image is processed by the image processor 36, for example, to isolate a region of interest for further evaluation using the artificial intelligence unit 46, or to enhance such further evaluation. To enhance detection of edges of components in the digital image, a Canny edge detection algorithm may be used on the digital image.

In step 82, the trained artificial intelligence unit 46 attempts to identify a pipe feature (in this case, the interface 44 or connection line between the connected pipes 16, 18) in the processed digital image. If a make-up procedure is being performed instead, the pipe feature to be identified would be the upper end 48 of the lower pipe 16.

In step 84, a determination is made whether the artificial intelligence unit 46 successfully identified the interface 44 or connection line between the connected pipes 16, 18.

In step 86, if the identification of the interface 44 or connection line is unsuccessful, this unsuccessful result (as well as the digital image) is stored as part of the data to be transmitted to the cloud 66 for further training of the central version of the artificial intelligence unit 46.

In step 88, remedial actions are taken to enhance the clarity of a subsequent digital image of the pipe connection 14 or otherwise enhance the ability of the artificial intelligence unit 46 to identify the pipe connection in the subsequent digital image. For example, the pipe connection 14 may be cleaned of any debris, etc., that might be obscuring the connection line, or equipment in a background of the pipe connection image may be moved.

Steps 78, 80, 82 and 84 are repeated if the identification of the interface 44 or connection line is unsuccessful. If a certain number of attempts are made and the identification is still unsuccessful, then an operator can manually identify the pipe feature in the last taken digital image and the procedure will skip to step 98.

If the identification of the interface 44 or connection line by the artificial intelligence unit 46 is successful, then in step 90 an operator evaluates whether the identified position is correct. For example, the operator can view a display of the digital image, with the identified position of the pipe feature indicated in the display.

If the identified position is not correct, then in step 92, the operator adjusts the indicated position of the pipe feature. In step 94, the incorrect identification of the pipe feature by the artificial intelligence unit 46, the corrected identification of the pipe feature by the operator and the digital image are stored as part of the data to be transmitted to the cloud 66 for further training of the central version of the artificial intelligence unit.

In step 90, if the operator determines that the identified position of the interface 44 or connection line in the digital image is correct, then in step 96, the operator approves the identified position. In step 98, the identified position of the interface 44 or connection line is transmitted to a calculation unit. The calculation unit may be a component of the image processor 36 or tong control unit 34, such as, a computing device or a programmable logic controller.

In step 100, a height corresponding to the pixel position of the interface 44 or connection line in the digital image is calculated using the calculation unit. In step 102, the digital image and the approved identified position of the interface 44 or connection line in the digital image are stored as part of the data to be transmitted to the cloud 66 for further training of the central version of the artificial intelligence unit.

In step 104, the calculated height of the interface 44 or connection line is transmitted to the tong control unit 34. The tong assembly 12 can then be moved to the well center and its height can be varied as needed by the positioning device 28, so that the rotary tong 24 is positioned above the pipe connection 14 and the back-up tong 26 is positioned below the pipe connection. The pipe connection 14 can then be broken-out as described above.

If the tong positioning procedure 70 is used to make-up a pipe connection, then instead of the interface 44 or connection line position being identified in the digital image, the upper end 48 of the lower pipe 16 will be identified in the digital image. The upper pipe 18 will be stabbed into the upper end 48 of the lower pipe 16 after the identified position of the upper end 48 in the digital image is approved (step 96).

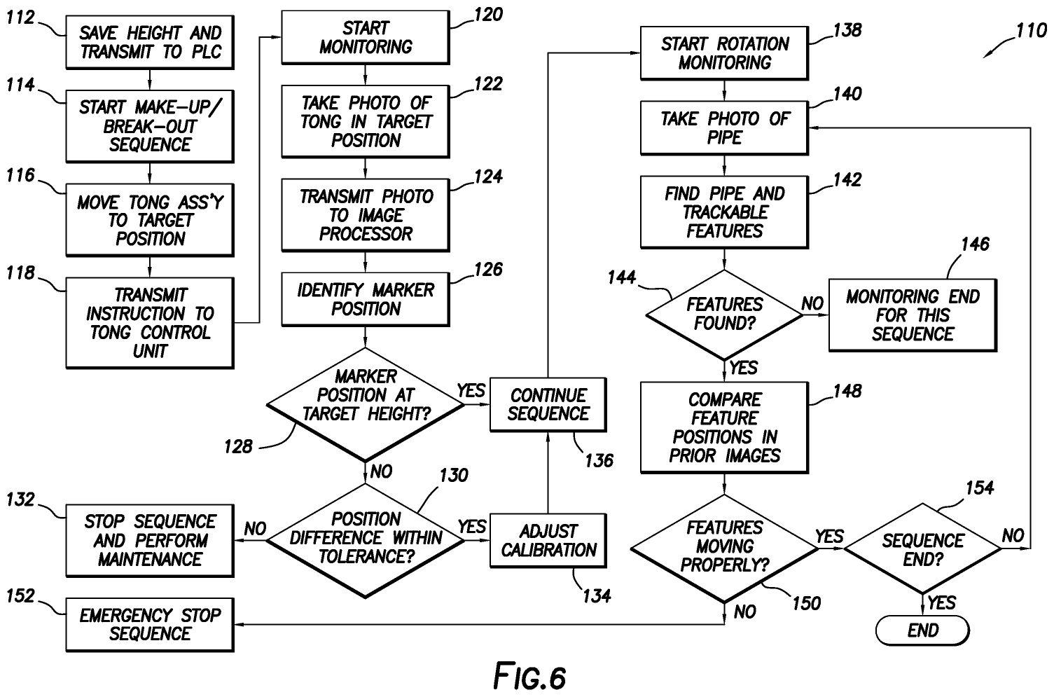

Referring additionally now to FIG. 6, a flowchart for an example of a procedure 110 of monitoring the make-up or break-out of the pipe connection 14 is representatively illustrated. The monitoring procedure 110 can be performed after the FIG. 5 tong positioning procedure 70. In that case, step 112 of the monitoring procedure 110 corresponds to step 104 of the tong positioning procedure 70.

In step 112, the calculated height of the interface 44 (in the case of a break-out) or upper end 48 of the lower pipe 16 (in the case of a make-up) is saved and transmitted to, for example, a programmable logic controller of the tong control unit 34. The calculated height is used to adjust the reference height of the tong positioning device 28 as described above.

In step 114, the make-up or break-out step sequence is initiated. This step may be performed manually by an operator, or automatically in some examples. If a make-up operation is being performed, then the upper pipe 18 is stabbed into the upper end 48 of the lower pipe 16 prior to starting the make-up step sequence.

In step 116, the tong assembly 12 is moved to a target position by the tong positioning device 28. In the target position, the rotary and back-up tongs 24, 26 are aligned with the central axis 22 at the well center, the rotary tong 24 is positioned above the pipe connection 14 and the back-up tong 26 is positioned below the pipe connection (which is not yet made-up if a make-up operation is being performed).

In step 118, an instruction is transmitted to the tong control unit 34 to begin the make-up or break-out. The instruction may be transmitted manually by an operator, or automatically once the tong assembly 12 is at the target position.

In step 120, monitoring of the make-up or break-out starts. The camera 38 is used to monitor the make-up or break-out by taking digital images (e.g., photos, pictures and/or videos) of the tong assembly 12 and the pipes 16, 18 prior to and during the make-up or break-out of the pipe connection 14.

In step 122, a digital image of the tong assembly 12 is taken after it has been moved to the target position (step 116). This digital image is taken to confirm whether the tong assembly 12 has indeed been moved to the target position.

In step 124, the digital image taken in step 122 is transmitted to the image processor 36. The image processor 36 processes the digital image (for example, using a Canny edge detection algorithm). If the calibration marker 42 is in the shape of a sphere, a Circle Hough Transform may be used on the processed digital image.

In step 126, the position of the calibration marker 42 is identified in the processed digital image. The trained artificial intelligence unit 46 is used to identify the calibration marker 42 in the digital image, as described above.

The identified pixel position of the calibration marker 42 corresponds to a reference height of the tong positioning device 28. However, since the tong positioning device 28 will typically comprise a mechanical, hydraulic and/or electrical apparatus, it is possible for the correlation between the positioning device reference height and the pixel position of the calibration marker to vary.

In step 128, a determination is made whether the position of the calibration marker 42 as identified in the processed digital image corresponds to the desired target height. This determination is made, in order to see if the tong positioning device 28 has indeed moved the tong assembly 12 to the target height.

In step 130, if the position of the calibration marker 42 as identified in the processed digital image does not correspond to the desired target height, a determination is made whether the difference is within an acceptable tolerance. If the difference is not within the acceptable tolerance, then in step 132 the make-up or break-out sequence is terminated and maintenance is performed on the tong positioning device 28. If the difference is within the acceptable tolerance, then in step 134 the algorithmic relationships that resulted from the calibration procedure are adjusted as needed, so that the tong positioning device 28 reference height will appropriately correspond to the actual calibration marker pixel position identified in the digital image taken by the camera 38.

In step 136, the make-up or break-out sequence is continued after it is either determined that the position of the calibration marker 42 as identified in the processed digital image does correspond to the desired target height (step 128), or the calibration algorithmic relationships have been appropriately adjusted (step 134). The jaws of the rotary and back-up tongs 24, 26 are activated to grip the upper pipe 18 and the lower pipe 16, the rotary tong rotates the upper pipe and torque is applied to the pipe connection 14 to make-up or break-out the connection. The lower pipe 16 should not rotate during the make-up or break-out of the pipe connection 14.

In step 138, a rotation monitoring sequence is initiated, in order to detect when or if the lower pipe 16 begins to rotate during the make-up or break-out of the pipe connection 14. It is desirable to detect such rotation of the lower pipe 16 as soon as it occurs, so that damage to the pipe or the jaws of the back-up tong 26 can be prevented.

In step 140, the camera 38 is used to take a digital image or video (which comprises a series of digital images) of the lower pipe 16 while the rotary tong 24 rotates the upper pipe 18. This digital image can include other components or equipment, such as, the tong assembly 12 and the upper pipe 18, but at least the lower pipe 16 should be clearly visible in the digital image. The digital image can be processed by the image processor 36 as described above (for example, by use of a Canny edge detection algorithm).

In step 142, the trained artificial intelligence unit 46 identifies the lower pipe 16 in the digital image taken in step 140. In addition, the artificial intelligence unit 46 identifies any features on the lower pipe 16 that can be used to track movement (such as rotation) of the lower pipe. In some examples, a specific distinctive type of mark (such as, a line or a particular shape) may be provided on the lower pipe 16 to assist in the identification by the artificial intelligence unit 46.

In step 144, a determination is made whether any trackable features can be identified on the lower pipe 16 in the digital image taken in step 140. If a trackable feature cannot be identified by the artificial intelligence unit 46, then the rotation monitoring sequence can be terminated in step 146. Alternatively, one or more additional attempts may be made to repeat steps 140, 142 and 144 until trackable features can be identified on the lower pipe 16 in the digital image taken in step 140. If the rotation monitoring sequence is terminated in step 146, then an operator can visually monitor the lower pipe 16 during the remainder of the make-up or break-out operation.

If one or more trackable features are identified in the digital image taken in step 140, then in step 148 the position of the feature in one digital image is compared to the position of the feature in a prior digital image, in order to determine whether the feature has moved. For example, a video of the lower pipe 16 taken by the camera 38 will include a series of digital images. By comparing a pixel position of a feature identified by the artificial intelligence unit 46 in one digital image to a pixel position of the same feature identified by the artificial intelligence unit in another digital image, movement of the feature can be detected.

In step 150, a determination is made whether the identified features are moving properly in the digital images taken by the camera 38. Preferably, no movement of the features is detected, but in some examples a small amount of movement may be acceptable.

If in step 150 it is determined that the features are not moving properly, then in step 152 an emergency stop sequence is executed. For example, the rotation of the upper pipe 18 by the rotary tong 24 is terminated and the jaws of the tongs 24, 26 are released from the pipes 16, 18.

If in step 150 it is determined that the features are moving properly (for example, there is a lack of rotation of the lower pipe 16), then the make-up or break-out operation continues. In step 154 a periodic determination is made whether the rotation monitoring sequence is complete and, if not, then the steps 140, 142, 144, 148 and 150 are repeated, as long as the make-up or break-out operation is being performed, trackable features can be identified on the lower pipe 16 in the digital images taken by the camera 38 (step 144) and the features properly move (step 150).

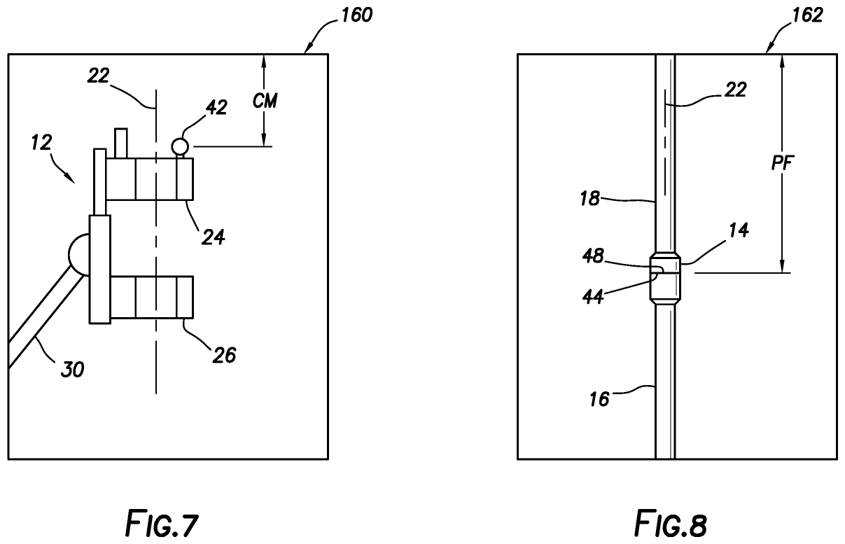

Referring additionally now to FIG. 7, an example of a digital image 160 taken by the camera 38 is representatively illustrated. The digital image 160 may be taken during training of the artificial intelligence unit 46 or during the calibration procedure described above.

If the digital image 160 is taken during training of the artificial intelligence unit 46, the image is processed (for example using a Canny edge detection algorithm, and optionally a Circle Hough Transform if the calibration marker 42 is spherically shaped). If the calibration marker 42 has a distinctive color, the image processor 36 may use one or more filters to exclude colors other than the distinctive color, so that the artificial intelligence unit 46 can more readily identify the calibration marker in the digital image 160. The processed image 160 is input to the artificial intelligence unit 46 either during initial training, or after the artificial intelligence unit has been initially trained to confirm whether the artificial intelligence unit can successfully identify the position of the calibration marker 42 in the digital image.

The identification of the position of the calibration marker 42 in the digital image 160 can include a pixel distance CM of the identified calibration marker below an upper edge of the digital image. Other pixel positions may be used in other examples, such as, a pixel distance of the calibration marker above a lower edge of the digital image 160, or a pixel distance from a left or right edge of the digital image.

If the digital image 160 is taken during the calibration procedure, then preferably the tong assembly 12 is moved to the well center, so that the rotary and back-up tongs 24, 26 are aligned with the central axis 22. A digital image 160 is taken with the tong assembly 12 positioned at two or more heights, and the pixel distance CM in each of the digital images is identified using the trained artificial intelligence unit 46. The resulting calibration algorithms will represent a direct relationship between the pixel distance CM in a digital image and a reference height of the tong positioning device 28.

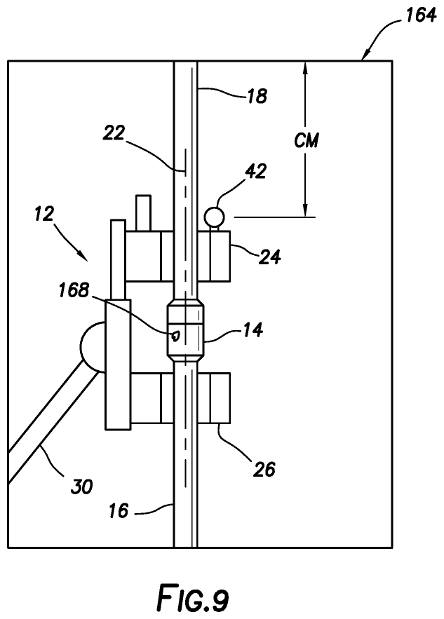

Referring additionally now to FIG. 8, an example of a digital image 162 of the connected pipes 16, 18 in a training procedure or a well operation is representatively illustrated. The digital image 162 may be used to train the artificial intelligence unit 46 to identify the pipe connection 14 or a feature thereof (such as, the interface 44 or connection line between the pipes 16, 18, or an upper end 48 of the lower pipe 16). If the artificial intelligence unit 46 is being trained to identify the upper end 48 of the lower pipe 16, then the upper pipe 18 may not be present in the digital image 162.

The identification of the position of the interface 44 or upper end 48 in the digital image 162 can include a pixel distance PF of the identified pipe feature below an upper edge of the digital image. Other pixel positions may be used in other examples, such as, a pixel distance of the pipe feature above a lower edge of the digital image 162, or a pixel distance from a left or right edge of the digital image.

The digital image 162 may be taken during a make-up or break-out procedure. For example, the digital image 162 may be used in step 82 of the FIG. 5 tong positioning procedure 70 to identify a pipe feature (such as, the interface 44 or connection line between the pipes 16, 18, or an upper end 48 of the lower pipe 16).

Referring additionally now to FIG. 9, an example of a digital image 164 of the tong assembly 12 and connected pipes 16, 18 in a well operation is representatively illustrated. A make-up or break-out operation may be performed when the camera 38 takes the FIG. 9 digital image 164.

The trained artificial intelligence unit 46 can identify the calibration marker 42 in the digital image 164, so that the pixel position (e.g., pixel distance CM from the top edge of the image 164) of the calibration marker can be determined. This pixel position of the calibration marker 42 may be used, for example, in step 128 of the FIG. 6 monitoring procedure 110 to confirm whether the tong positioning device 28 has appropriately positioned the tong assembly 12 to make-up or break-out the pipe connection 14.

The digital image 164 can be used in step 142 of the monitoring procedure 110 to identify any trackable features 168 on the lower pipe 16, or as one of a series of digital images in step 150 to determine whether the features are moving properly during the make-up or break-out.

It may now be fully appreciated that the above disclosure provides significant advancements to the arts of constructing and utilizing tong assemblies and systems with well operations. In examples described above, the artificial intelligence unit 46 can identify a calibration marker 42 and features of the pipes 16, 18 (such as, the interface 44, the upper end 48, or features 168 to track rotation of the lower pipe) in digital images 160, 162, 164 taken by the camera 38.

The above disclosure provides to the art a system 10 for use with a subterranean well. In one example, the system 10 can include a tong assembly 12, a tong positioning device 28 configured to adjust a vertical height of the tong assembly 12, a calibration marker 42 secured to the tong assembly 12, and a camera 38 disposed at a camera position at which the calibration marker 42 is within a field of view 40 of the camera 38. The calibration marker 42 may comprise a sphere.

The system 10 may include an image processor 36 configured to identify the calibration marker 42 in a first digital image 160 taken by the camera 38. The image processor 36 may be further configured to identify a pipe feature (such as, the interface 44, the upper end 48, or features 168) in a second digital image 162 taken by the camera 38.

The image processor 36 may comprise an artificial intelligence unit 46. The image processor 36 may be configured to filter from the first digital image 160 colors other than a color of the calibration marker 42.

A method of vertically positioning a tong assembly 12 is also provided to the art by the above disclosure. In one example, the method can include: taking a first digital image 160 of a tong assembly 12 and a calibration marker 42; identifying a pixel position of the calibration marker 42 in the first digital image 160; and adjusting a height of the tong assembly 12 based in part on the pixel position of the calibration marker 42.

The method can include, prior to the taking of the first digital image 160, displacing the tong assembly 12 to a location proximate a central axis 22 of a well, and measuring a distance between the calibration marker 42 and a camera 38.

The method can include, prior to the step of adjusting the height of the tong assembly 12, taking a second digital image 162 of a pipe feature, and identifying a pixel position of the pipe feature in the second digital image 162. The pipe feature may be a pipe connection interface 44, an upper end 48 of a pipe 16, or a feature 168 to enable detection of rotation of the pipe 16.

The method may include inputting the first and second digital images 160, 162 to an artificial intelligence unit 46. The artificial intelligence unit 46 may perform the steps of identifying the pixel position of the calibration marker 42 and identifying the pixel position of the pipe feature.

The step of identifying the pixel position of the calibration marker 42 may include performing a Circle Hough Transform on the first digital image 160.

One example of vertically positioning a tong assembly 12 described above can include training an artificial intelligence unit 46 to identify pixel positions of a calibration marker 42 in respective first training digital images 160 of the calibration marker 42 taken by a camera 38; training the artificial intelligence unit 46 to identify pixel positions of a pipe feature in respective second training digital images 162 of the pipe feature taken by the camera 38; taking a third operating digital image 162 of the pipe feature; inputting the third operating digital image 162 to the artificial intelligence unit 46, whereby the artificial intelligence unit 46 identifies a pixel position of the pipe feature in the third operating digital image 162; and adjusting a height of the tong assembly 12 to correspond to the pixel position of the pipe feature in the third operating digital image 162.

The adjusting step may include positioning a first tong 24 of the tong assembly 12 above the pipe feature and positioning a second tong 26 of the tong assembly 12 below the pipe feature. The adjusting step may include changing a reference height of a positioning device 28 connected to the tong assembly 12.

The method may include determining an algorithmic relationship between the pixel positions of the calibration marker 42 in the respective first training digital images 160 and corresponding reference heights of a tong assembly positioning device 28 at each of the pixel positions of the calibration marker 42 in the respective first training digital images 160.

The artificial intelligence unit 46 may comprise at least one of the group consisting of an artificial neural network, a genetic algorithm, a convolutional neural network, a recurrent neural network and machine learning.

The step of training the artificial intelligence unit 46 to identify the pixel positions of the calibration marker 42 may include performing Circle Hough Transforms on the first training digital images 160.

The method may include transmitting the third operating digital image 162 and the pixel position of the pipe feature in the third operating digital image 162 to a networked cloud 66 for further training of the artificial intelligence unit 46.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” “upward,” “downward,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A system for use with a subterranean well, the system comprising:
a tong assembly;
a tong positioning device configured to adjust a vertical height of the tong assembly;
at least one calibration marker secured to the tong assembly; and
a camera disposed at a camera position at which the at least one calibration marker is within a field of view of the camera.

2. The system of claim 1, in which the at least one calibration marker comprises a sphere.

3. The system of claim 1, further comprising an image processor configured to identify the at least one calibration marker in a first digital image taken by the camera.

4. The system of claim 3, in which the image processor is further configured to identify a pipe feature in a second digital image taken by the camera.

5. The system of claim 3, in which the image processor comprises an artificial intelligence unit.

6. The system of claim 3, in which the image processor is further configured to filter from the first digital image colors other than a color of the at least one calibration marker.

7. A method of vertically positioning a tong assembly, the method comprising:
taking a first digital image of the tong assembly and at least one calibration marker;
identifying a pixel position of the at least one calibration marker in the first digital image; and
adjusting a height of the tong assembly based in part on the pixel position of the at least one calibration marker.

8. The method of claim 7, further comprising, prior to the taking of the first digital image, displacing the tong assembly to a location proximate a central axis of a well, and measuring a distance between the at least one calibration marker and a camera.

9. The method of claim 7, further comprising, prior to the adjusting the height of the tong assembly, taking a second digital image of a pipe feature, and identifying a pixel position of the pipe feature in the second digital image.

10. The method of claim 9, in which the pipe feature is one of the group consisting of a pipe connection interface and an upper end of a pipe.

11. The method of claim 9, further comprising inputting the first and second digital images to an artificial intelligence unit.

12. The method of claim 11, in which the artificial intelligence unit performs the identifying the pixel position of the at least one calibration marker and the identifying the pixel position of the pipe feature.

13. The method of claim 7, in which the identifying the pixel position of the at least one calibration marker comprises performing a Circle Hough Transform on the first digital image.

14. A method of vertically positioning a tong assembly, the method comprising:
training an artificial intelligence unit to identify pixel positions of at least one calibration marker in respective first training digital images of the at least one calibration marker taken by a camera;
training the artificial intelligence unit to identify pixel positions of a pipe feature in respective second training digital images of the pipe feature taken by the camera;
taking a third operating digital image of the pipe feature;
inputting the third operating digital image to the artificial intelligence unit, whereby the artificial intelligence unit identifies a pixel position of the pipe feature in the third operating digital image; and
adjusting a height of the tong assembly to correspond to the pixel position of the pipe feature in the third operating digital image.

15. The method of claim 14, in which the adjusting comprises positioning a first tong of the tong assembly above the pipe feature and positioning a second tong of the tong assembly below the pipe feature.

16. The method of claim 14, in which the adjusting comprises changing a reference height of a positioning device connected to the tong assembly.

17. The method of claim 14, further comprising determining an algorithmic relationship between the pixel positions of the at least one calibration marker in the respective first training digital images and corresponding reference heights of a tong assembly positioning device at each of the pixel positions of the at least one calibration marker in the respective first training digital images.

18. The method of claim 14, in which the artificial intelligence unit comprises at least one of the group consisting of an artificial neural network, a genetic algorithm, a convolutional neural network, a recurrent neural network and machine learning.

19. The method of claim 14, in which the training the artificial intelligence unit to identify the pixel positions of the at least one calibration marker comprises performing Circle Hough Transforms on the first training digital images.

20. The method of claim 14, further comprising transmitting the third operating digital image and the pixel position of the pipe feature in the third operating digital image to a networked cloud for further training of the artificial intelligence unit.
